(19) United States
(12) Patent Application Publication
(10) Pub. No.: US 2007/0175213 A1
(43) Pub. Date: Aug. 2, 2007

(54) Shape memory alloy actuator

(75) Inventors: Roy Featherstone, Canberra (AU); Yee Harn Teh, Canberra (AU)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: The Australian National University, Acton (AU)

(21) Appl. No.: 10/589,090

(22) PCT Filed: Feb. 8, 2005
(86) PCT No.: PCT/AU05/00154

§ 371 Date: Mar. 29, 2007

(30) Foreign Application Priority Data
Feb. 9, 2004 (AU) 2004900618

(51) Int. Cl. F01B 29/10; F02G 1/04

(52) U.S. Cl. 60/527

(57) ABSTRACT

A controller (44) for a SMA actuator (2) includes an electgric power source (46) for applying an electric current through an SMA element (8), a sensor (48) to detect change in an electric resistance of the element (8); and a regulator (50) for controlling the magnitude of the applied electric current. The regulator (50) applies a first current above a safe limit current for the element (8) until a selected change in the electric resistance is detected and applies a second current less than the first current after the change is detected.

### FIELD OF THE INVENTION

The present invention relates to a shape memory alloy actuator, and more particularly, to a controller for a shape memory alloy actuator.

### BACKGROUND OF THE INVENTION

Shape memory alloys (hereinafter referred to as “SMA”s) are a specific group of electrically conducting materials sharing a particular physical property. In a solid state, they have two different crystalline states or phases, a low-temperature phase called martensite, and a high-temperature phase called austenite.

A material formed from a SMA and having a largely martensite phase typically has a low yield strength, and can be subjected to significant strains and plastic deformation by the application of a relatively small force. If the deformed material is then heated so as to revert to a largely austenite phase, the material recovers its original shape. The shape recovery of SMAs is accompanied by a large force that is capable of doing a significant amount of mechanical work, and it is this property of SMAs that is utilised by SMA actuators to convert electrical or heat energy into mechanical energy.

There is a limit to the strain that can be applied to a SMA in its martensite phase and fully recovered upon heating. This limit is different for each alloy. For the nickel-titanium SMA known as nitinol, for example, which is the most commonly used alloy for SMA actuators, the limit is about 8%. However, actuators employing nitinol elements generally don't use strains greater than about 4%, as strains higher than this can cause rapid fatigue. SMAs having a largely austenite phase are normally incapable of tolerating strains of such a large magnitude.

SMA actuators generally operate by stretching at least one relatively cool SMA element or portion, typically in the form of either a straight wire or coil, having a largely martensite phase, by the application of an external force. The external force may be supplied by a spring, a weight or another actuator, for example. The wire or coil is then heated, whereupon it converts to a substantially austenite phase and contracts to its original shape with a considerable force that can be used to perform mechanical work. When the wire or coil has cooled sufficiently, it will revert to a substantially martensite phase, whereupon it may be again stretched and plastically deformed by the application of an external force such as that applied by a spring, a weight or another actuator.

It will be appreciated from the above that the speed at which the wire or coil of the actuator may be contracted and extended, and hence the actuation speed of the actuator, are limited by both the cooling and heating rates of the wire or coil. The rate at which the wire or coil is cooled may be increased by using water or forced-air cooling, for example, or simply even by using a thinner wire or coil. Practical limitations of SMAs however, generally restrict the rate at which the wire or coil can be heated.

Heating of the wire or coil is usually accomplished by Joule heating whereby an electrical current is applied through the wire or coil, with the wire or coil's resistivity causing heat generation. One approach for increasing the rate at which the wire or coil is heated may be to apply a larger current, but this approach is typically not employed in practice as it runs the risk of overheating the wire or coil and thereby permanently damaging the SMA. For this reason, SMA data sheets usually specify a “safe limit current” (equivalent to a safe power per unit length of wire) which can be applied through a SMA element or portion without overheating the SMA, and electrical heating systems for heating SMA elements or portions of SMA actuators are usually designed to deliver no more than this safe limit current. However, it will be appreciated that heating a SMA element or portion with an electrical current beyond the safe limit current does not itself damage the SMA; it is the temperature of the wire or coil that must not exceed a certain level.

### SUMMARY OF THE INVENTION

Preferred embodiments of the present invention seek to provide a controller for improving the speed of actuation of SMA actuators by increasing the rate at which they are heated.

According to one aspect of the present invention, there is provided a controller for a SMA actuator, the SMA actuator including at least one SMA element, the controller including:
an electrical power source for applying an electrical current through the SMA element;
a sensor to detect change in an electrical resistance of the SMA element; and
a regulator for controlling a magnitude of the applied electrical current, the regulator applying a first current above a safe limit current for the SMA element until a selected change in the electrical resistance is detected and applying a second current less than the first current after the change is detected.

Preferably, the selected change corresponds to a range of temperatures for the SMA element at and below which thermal damage of the SMA element will not occur.

Preferably, the change in the electrical resistance of the SMA element is detected by measuring the electrical resistance of the SMA element. Alternatively, the change in the electrical resistance of the SMA element may be detected by measuring the electrical impedance or other characteristic indicative of the electrical resistance of the SMA element, like electrical resonant frequency.

Preferably the electrical resistance of the SMA element is detected substantially continuously or at selected intervals.

In one practical form of the invention, the at least one SMA element may be in the form of one or more straight wires, for example. It will be appreciated that the at least one SMA element may take other forms though. For example, they may be in the form or one or more helically wound wires that may be self-supporting coils, or otherwise.

When the wire is cool, having a substantially 100% martensite phase, the wire may be relatively easily strained or plastically deformed by the application of a relatively small force. The strained wire may then be heated by applying an electrical current through the wire to promote a phase change in the wire from martensite phase to austenite phase, such that the wire contracts and returns to its original shape. When the wire is heated sufficiently, the wire will have a substantially 100% austenite phase. To prevent damaging the SMA however, the temperature is maintained below a temperature associated with the SMA at which thermal damage will occur. To optimise the heating of the wire while maintaining the temperature below the temperature at which thermal damage will occur, embodiments of the present invention use the measured electrical resistance of the wire to determine a range for the temperature of the wire.

The resistances of the phases of SMAs generally vary considerably with alloy composition. The resistivity in the martensite phase of the SMA sold under the trade mark “Flexinol”, for example, which is made of the SMA nitinol, is about 15% to 20% higher than the resistivity in the austenite phase. It will be appreciated that this will not be true for all SMAs, and it is expected that this difference would be subject to considerable variation between alloys of different compositions. It is even contemplated that there may exist alloys where the martensite phase has a lower resistance than the austenite phase. In any case, the present invention is not limited by which phase has a higher resistance. Rather embodiments of the present invention may be realised when the resistances of the phases are different and this difference is sufficiently large so as to serve as a useful measurement of the temperature of the SMA.

SMAs generally exhibit a relatively large thermal hysteresis, whereby the martensite phase starts changing to austenite phase upon heating at a higher temperature than the temperature at which austenite phase starts changing to martensite phase upon cooling. The magnitude of the hysteresis generally varies with the alloy type, but typically is within the range of about 10 to 50 degrees Celsius. While this means that the electrical resistance cannot be used to directly establish the exact temperature of the SMA, it is possible to identify a range of temperatures that are consistent with a given electrical resistance, and thereby to identify upper and lower temperature limits for a given electrical resistance. This allows a “safe resistance” corresponding to one of the upper temperature limits to be identified. From the identified safe resistance, a safe resistance range for the heating of the element, preferably incorporating a safety factor or margin, is able to be determined.

The identified safe resistance will effectively be either an upper limit or a lower limit of this safe resistance range. For example, in the instance the austenite phase of a SMA exhibits a lower resistance than its martensite phase, electrical resistances corresponding to when the element is not overheated will be of a larger magnitude than electrical resistances corresponding to when the element may be overheating or potentially has been overheated, and the identified safe resistance, preferably plus a safety factor or margin, will therefore define a lower limit of the safe resistance range. Conversely, when the austenite phase exhibits a higher electrical resistance than the martensite phase, electrical resistances corresponding to when the element is not overheated will be of a lesser magnitude than electrical resistances corresponding to when the element may be overheating or potentially has been overheated, and the identified safe resistance, preferably minus a safety factor or margin, will therefore define an upper limit for the safe resistance range.

The net effect of an embodiment according to the present invention is a faster motion SMA actuator when compared with previous control schemes. By limiting the electrical current to the SMA element's safe limit current whenever the measured electrical resistance falls outside the safe resistance range for the element, a controller according to an embodiment of the present invention is able to use the measured electrical resistance of the SMA element to ensure that the element is not overheating or overheated. This allows a controller according to an embodiment of the present invention to apply a current greatly in excess of the SMA element's safe limit current, facilitating quicker heating, and therefore correspondingly a quicker phase change within the element and a quicker development of motive force. Applying a large current across a SMA element to heat the element quicker, even if the current is in excess of the safe limit current, is safe until the resistance of the element departs from the determined safe resistance range. Once the electrical resistance of the element departs from the safe resistance range however, the controller can no longer be sure that the SMA element is not overheating or overheated. At that point, the current must be reduced to a safe level or else the SMA may overheat.

Preferably, the controller progressively reduces the current applied through the SMA element as a function of the measured electrical resistance when heating the element instead of changing abruptly in response to the change in the electrical resistance. More preferably, the controller smoothly reduces the current applied through the SMA element as a function of the measured electrical resistance. The reduction of the current may occur over a range of electrical resistances within, but adjacent to the boundary of, safe resistance, for example. A progressive or smooth reduction in the applied current that avoids abrupt changes in the current, may be used in practice to improve the motion tracking accuracy of an embodiment of the present invention.

There is often quite a large gap for SMAs between the top of the “operating temperature range” (the temperature range over which the phase transformation between martensite phase and austenite phase occurs) and the temperature at which thermal damage will occur. For elements formed from the SMA nitinol, for example, the top of the operating temperature range is about 100 degrees Celsius, but the alloy can withstand temperatures above 200 degrees Celsius without sustaining thermal damage. According to an embodiment of the present invention, it is quite acceptable for the temperature of the SMA element to rise above its operating temperature range during heating of the element, and even for the heating system to continue passing a current through the element, so long as the current is limited to no greater than the safe limit current whenever the measured electrical resistance lies outside the identified safe resistance range.

Typically the resistivity of a particular SMA phase is determined from data sheets having the expected values for the electric resistances of the phases. Generally these resistances are determined by empirically testing a representative sample of each batch during manufacture of SMA elements. The use of such data sheets to determine the electrical resistance relies on the assumption that all actuators made in a particular batch, or to a particular design, are the same.

Preferably, the resistivity of the phases of the SMA element(s) of a SMA actuator are alternatively obtained by testing each element, with the controller having an initialisation or calibration mode in addition to a normal operating mode, the initialisation or calibration mode measuring and recording the hot and/or cold electrical resistances of the SMA element. The controller may perform such an initialisation or calibration operation either automatically upon the SMA actuator being powered up or upon command. The initialisation or calibration operation may include applying at least one test current through the SMA element, measuring the electrical resistance to the test current, and determining the selected change from the measured resistance.

While a controller with an initialisation of calibration measurement capability is somewhat preferable to one without, measuring hot (austenite phase) resistances implies heating up an actuator, which in turn implies some movement, and in practice, this may be undesirable. For example, if a controller according to an embodiment of the present invention was used to control a robot operating in a cluttered environment, it may be important that the robot make only commanded movements, as other movement may result in a collision and possible damage. As such, if the hot resistance (austenite phase) can be relied on as being a known scalar multiple of the cold resistance (martensite phase), whereby the controller can get away with only a cold measurement, it may be preferable alternatively just to measure and record the cold resistance.

In another alternative, it may be possible to measure the relevant properties of the SMA element(s) of an actuator before it is installed, or during the commissioning phase of a complete SMA actuated device or system.

The resistance of a piece of metal also varies with its dimensions, as would be the case for a SMA wire forming part of a typical SMA actuator that reciprocally extends and contracts. A stretched wire will have a higher resistance simply because it is longer. At higher temperatures of a SMA (the area of interest), the strain on the SMA element (around 1%, for example) should be relatively small and correspondingly strain induced variations should also be relatively small. Thus, the strain induced effect on the resistance of a largely austenite phase SMA is typically quite small in comparison to resistance changes due to temperature associated phase changes. Hence, while strain induced variations would still need to be accounted for, they do not affect the resistance of a hot (austenite) SMA to such an extent that these variations undermine the ability to determine a practical range for the temperature of a SMA element from a measured electrical resistance.

In one preferred embodiment, the controller further includes a motion control system for computing the desired degree of actuation of each element as a function of the discrepancy between a specified desired motion or position of an output element of the SMA actuator for doing mechanical work and a detected actual motion or position of the output element. Typically such a motion control system would have access to other sensor data indicating the positions of various parts of the mechanical system under control. The gain of such a system is preferably set high so that anything more than a small position error will, after having been multiplied by the gain, result in a correctional signal that exceeds the safe limit current. When the measured resistance of each SMA element is within the safe resistance range, thereby indicating the element is not overheated, the current applied across the element will be the lesser of that determined by the correctional or command signal and the maximum electrical current that may be supplied by the electrical power source.

A preferred embodiment according to the present invention allows a SMA element to be held in a hot state (ie, largely austenite phase) should this become necessary with a further current significantly less than the safe limit current. The further current may be significantly less than the safe limit current quoted in or deducible from data sheets accompanying the SMA, while still being large enough to maintain the SMA in its hot phase. By choosing a lesser current below the data sheet value, it is possible to reduce the average power consumption of a SMA actuator during periods when rapid motion is not required.

The electrical resistance of the SMA element(s) of an actuator measured during the heating of the element(s) may also be compared with predetermined values for the maximum and minimum allowable resistances indicative of when the actuator is functioning normally. If the measured resistance(s) of the element(s) exceeds a predetermined upper operating limit or falls below a predetermined lower operating limit, the controller may issue a malfunction or error signal indicating that the actuator is not functioning correctly.

According to a further aspect of the present invention, there is provided a SMA actuator including:
at least a first SMA element;
an output element operably associated with the SMA element, the output element moving in response to the actuation of the SMA element; and
a controller as defined above for controlling the actuation of the SMA element.

Preferably, the SMA actuator includes a second SMA element, the SMA elements being operably arranged so that the contraction of one of the SMA elements complementarily exerts a stretching force on the other of the SMA elements. In one practical form of the invention wherein the SMA elements are formed from a pair of SMA elements, when an initially stretched one of the pair of SMA elements having a largely martensite phase is contracted by heating, it may exert a stretching force on its cooler largely martensite phase antagonistic partner. Hence, as one of the elements contracts, the other of the elements is thereby strained and plastically deformed. This provides for the ongoing and substantially continuous operation of the actuator by the alternate heating of the elements without the need for a separate external mechanism for stretching the elements.

In accordance with a further aspect of the present invention, there is provided a method of heating at least one SMA element of an SMA actuator, the method including:
applying an electrical current through the SMA element; and
detecting change in the electrical resistance of the SMA element; wherein
a first current above a safe limit current for the SMA element is applied until a selected change in the electrical resistance is detected and a second current less than the first current is applied after the change is detected.

### BRIEF DESCRIPTION OF THE DRAWINGS

The present invention will now be described, by way of non-limiting example only, with reference to the accompanying drawings, in which:

FIG. 1 is a view of a SMA actuator;

FIG. 2 is a schematic view of a controller for a SMA actuator;

FIG. 3 is a graph of the electric resistance against power of a wire formed from nitinol during a heating and cooling cycle of the wire; and

FIG. 4 is a graph showing both the input command position and the response position of the output element of an actuated SMA actuator.

### DETAILED DESCRIPTION

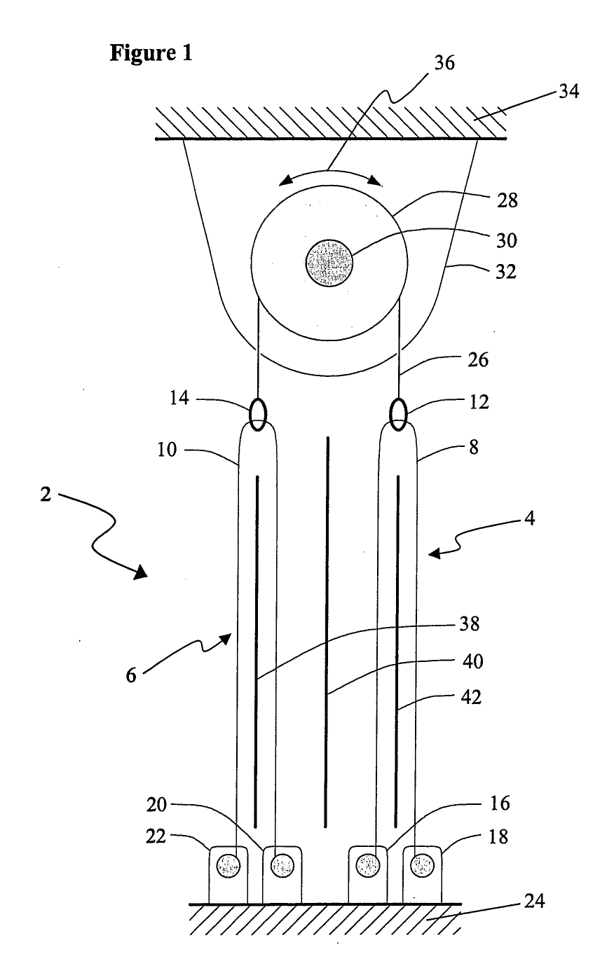

A SMA actuator 2 formed by a complementary antagonistic pair of SMA elements 4, 6 in the form of wires 8, 10 is shown in FIG. 1. The wires are looped through eyelets 12, 14, with the each of the ends of the looped wires 8, 10 being connected to anchor points 16, 18, 20, 22. The anchor points 16, 18 both mechanically anchor the wire 8 to a first support 24 of the actuator 2 and provide an electric contact for applying an electrical current from an electrical power source (not shown in FIG. 1) through the wire 8 as will be described below, while the anchor points 20, 22 similarly anchor and provide an electrical contact for the wire 10. The eyelets 12, 14 are connected to the ends of a chord 26 that operably passes around a pulley 28, which is connected to an output element or shaft 30 for doing mechanical work. The pulley 28 and the shaft 30 are rotatably mounted to a bracket 32 that is mounted to a second support 34 of the actuator 2. The pulley 28 and output shaft 30 may rotate in either of the directions indicated by the arrow 36. In practice, the output shaft 30 could be used to operate a camera pan or tilt mechanism, or in other applications to actuate small, lightweight robots or the fingers of a robot hand, for example.

While the SMA actuator 2 will be described hereinafter with reference to the reciprocal rotary motion of the output shaft 30, it will be appreciated that an alternative embodiment of the present invention may be applicable to an actuator performing mechanical work by way of the linear actuation of an output element.

In normal operation of the actuator 2, which will be further described below, the wires 8, 10 are generally kept taut, with guards 38, 40, 42 provided to isolate the electrical current conducting wires 8, 10. In the case either of the wires 8, 10 become slack, such as may occur if either of the SMA elements 4, 6 are mechanically overloaded or a controller for controlling operation and heating of the elements 4, 6 is turned off, the guards 38, 40, 42 function to prevent the wires 8, 10 from touching one another and short circuiting.

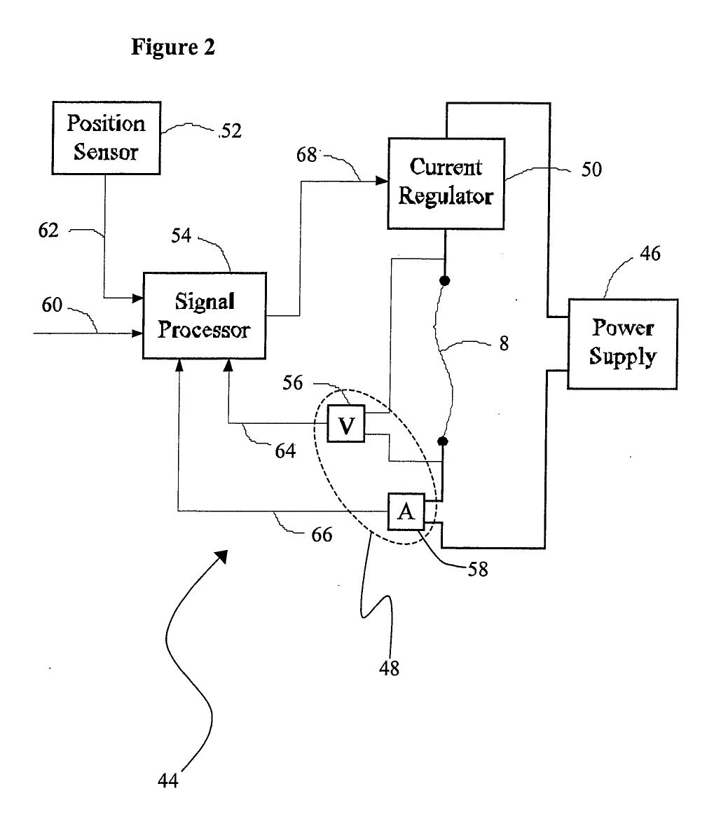

A controller 44 suitable for controlling and heating either of the SMA elements 4, 6 is shown in FIG. 2, the operation of which will initially be described with reference to heating the element 4.

The controller 44 includes an electrical power source in the form of a power supply 46 for applying an electrical current through the wire 8, a resistance sensor 48 to detect changes in the electrical resistance of the wire 8, a current regulator 50 for regulating the magnitude of the electrical current applied through the wire 8, a position sensor 52 for detecting the position of the output element or shaft 30 or the position of a mechanical component that may be closely coupled in practice to the output element or shaft 30, and a signal processor 54. The resistance sensor 48 includes a voltage sensor 56 for detecting the electric voltage across the wire 8 and a current sensor 58 for detecting the electric current passing through the wire 8.

In operation of the controller 44 to heat the wire 8, the signal processor 54 of the controller 44 receives a command position signal 60 for the output element 30 from an external source (not shown), a measured position signal 62 for the output element 30 from the position sensor 52, a detected electric voltage signal 64 from the voltage sensor 56 for the wire 8, and a detected electric current signal 66 from the current sensor 58 for the wire 8. In response to a difference between the command position signal 60 and the measured position signal 62, the controller 44 determines a safe maximum heating current for rapidly heating the wire 8 in accordance with the measured electrical resistance of the wire 8, as will be detailed below.

The electric current applied through the wire 8 may be either AC (alternating current) or DC (direct current). In the case of DC it may be either a steady current or an intermittent one such as might be produced by a switch-mode regulator or power source. In the instance of either AC or intermittent DC, the magnitude of the applied current is preferably referred to in terms of the RMS (root-mean-square) value rather than the peak or average value, as the primary consideration is how much heat the current will produce. DC is preferable to AC in so much as it is generally easier to control and to make accurate resistance measurements.

One controller 44 may be used to selectively rapidly heat the wire 8 of the actuator 2 shown in FIG. 1, and a separate like controller may be used to selectively rapidly heat the wire 10, so that the wires 8, 10 are able to be alternately heated to rotate the output shaft 30 in alternate directions. While it is possible that multiple elements 4, 6 may be simultaneously controlled by providing a separate controller 44 for each element 4, 6, preferably the controllers 44 for each element 4, 6 are adapted to share several parts. In particular, it may be practical for the controllers 44 to share a single signal processor 54 to control all of the elements 4, 6 in the system or one signal processor 54 per subsystem, and for the controllers 44 to use a single or a small number of power supplies 46 to power all of the elements 4, 6. If a single signal processor 54 was used to determine both the currents to be applied through each of the wires 8, 10 of the antagonistic elements 4, 6 in the actuator 2, then a motion control law that was specifically designed for antagonistic pairs may be able to be used.

In FIG. 1, each of the wires 8, 10 are shown stretched half way between a minimum and a maximum operating strain for each wire 8, 10. If the wire 8 is heated by the application of an electric current through the wire 8 in response to a difference between a command position signal 60 and measured position signal 62 in relation to the position of the shaft 30, the wire 8 will contract, pulling downward on the eyelet 12 (as viewed in FIG. 1) connected to the chord 26, and thereby rotating the pulley 28 (and output element or shaft 30) in a clockwise direction (as viewed in FIG. 1) and extending or straining the cooler wire 10 a corresponding amount. If the wire 8 is subsequently allowed to cool and the wire 10 is then heated by the application of an electric current through the wire 10 in response to a further command position signal 60, the wire 10 will contract, rotating the pulley 28 and output shaft 30 in an anti-clockwise direction (as viewed in FIG. 1) and extending or straining the wire 8. By the alternate heating of the wires 8, 10, electric or heat energy may be used to perform mechanical work in the form of the reciprocal rotation of the shaft 30. The controllers 44 provide for the rapid heating of the wires 8, 10 and therefore the rapid actuation of the output shaft 30 without overheating and thereby permanently damaging the wires 8, 10, by determining and applying a safe maximum heating current through the wires 8, 10 as will be described below.

According to an embodiment of the present invention, large currents that would be capable of overheating the SMA wires 8, 10 if applied long enough are selectively applied through the wires 8, 10 while the measured resistance lies within a predetermined safe resistance range as determined by the controllers 44. Whenever the measured resistance in either of the wires 8, 10, as detected by the resistance sensors 48, lies outside the safe resistance ranges determined for the wires 8, 10, the current is restricted to the safe limit current for the wires 8, 10. Preferably, the power supply 46 is capable of supplying, and the current regulators 50 are each capable of applying, a current substantially in excess of the safe limit current for the SMA wires 8, 10. Based on the commanded and actual motions or positions of the output shaft 30, the signal processors 54 of the controllers 44 may calculate substantially constantly or at frequent selected intervals a tentative or provisional command current for each wire 8, 10, but instead of comparing it with the safe limit current, the signal processor 54 calculates the resistance of the SMA (from the measured voltage signals 64 and current signals 66 of the resistance sensors 48) and computes safe maximum heating currents for each wire 8, 10 as a function of the resistance. The actual current command signals 66 for each wire 8, 10 are then the lesser of the tentative or provisional command currents and the computed safe maximum heating currents from the electrical resistance of the wires 8, 10.

An example method for determining the safe maximum heating currents for the rapid heating of the wires 8, 10 of the actuator 2 in which the wires 8, 10 are formed from a SMA where the resistance drops as the material transforms from martensite to austenite phase is detailed below. The wires 8, 10 may be formed from a nickel-titanium SMA like nitinol, for example.

A safe resistance is initially identified for each wire 8, 10 in the form of threshold resistances, Rₜₕᵣₑₛₕ, that correspond to a martensite ratio (the ratio of martensite phase present to austenite phase) close to but distinguishable from zero, that are able to be used when determining the heating currents. Preferably the threshold resistances for each wire 8, 10 include a safety factor or margin, to allow for changes in the resistances of the wires 8, 10 with their changing dimensions during actuation. The threshold resistances for each wire 8, 10 are used to mark the boundary threshold between resistance values that imply that the wires 8, 10 are at a safe operating temperature and resistance values that do not. In the case of nitinol, resistances greater than or equal to the threshold resistance can be described as safe resistances, since they imply that the SMA is not overheating. While resistances less than the threshold resistance are not necessarily unsafe, there is the possibility that the SMA is overheating or has overheated.

One way that the threshold resistance could be established as part of an initialisation phase is to apply the safe limit current immediately and wait for the measured resistance value to stabilise, for example. This value, when adjusted in line with a desired selected safety factor or margin, can be used as the threshold resistance.

In a first heating strategy, the safe maximum heating current, Iₘₐₓ, for heating the wires 8, 10 at any particular time may be calculated separately for each of the wires 8, 10 substantially continuously or at frequent selected intervals according to:
If(Rₘₑₐₛ<Rₜₕᵣₑₛₕ) Iₘₐₓ=I_{safe}
Else Iₘₐₓ=I_{high}

Where
Iₘₐₓ=safe maximum heating current that may be applied to either of the wires 8, 10 at any particular time,
Rₜₕᵣₑₛₕ=threshold resistance of the wires 8, 10;
Rₘₑₐₛ=measured electrical resistance of the wires 8, 10;
I_{safe}=current sufficient to heat the SMA but insufficient to overheat it (such as the safe limit current); and
I_{high}=maximum current intended to heat the SMA wires 8, 10 rapidly that may also be capable of overheating them if applied long enough.

The value of the I_{high} should be chosen at or below the maximum practical current of the electric power supply 46. The actual heating current used to heat the wires 8, 10 is controlled in such a manner as to be always less than or equal to the maximum current I_{high}.

In an alternate second heating strategy for determining the current heating the wires 8, 10, the calculation of Iₘₐₓ may be modified so as to make a progressive or smooth transition between I_{safe} and I_{high} over a range of resistances from Rₜₕᵣₑₛₕ to a selected resistance Rᵣₐₘₚ. The value selected for Rᵣₐₘₚ will effect the behaviour of the system, but there are no particular constraints on its value other than being on the safe side of Rₜₕᵣₑₛₕ. The selection of Rᵣₐₘₚ involves a trade-off between a smooth transition of the actuator and the actuation speed. For example, a motion control law may require a smooth transition in order to achieve accurate trajectory tracking, and this may be done by selecting Rᵣₐₘₚ relatively different to Rₜₕᵣₑₛₕ. Alternatively, a motion control law may require rapid heating and actuation by selecting Rᵣₐₘₚ similar to Rₜₕᵣₑₛₕ. It will be appreciated though, that the penalty for making the transition too abrupt (Rᵣₐₘₚ too close to Rₜₕᵣₑₛₕ), which is a rough transition and reduced trajectory tracking accuracy, needs be set off against the penalty for making the transition too prolonged (Rᵣₐₘₚ too far from Rₜₕᵣₑₛₕ), which is a loss of heating speed and therefore a loss of actuation speed.

For example, if it is desired that the safe maximum heating current, Iₘₐₓ, varies linearly between these two resistances, Rᵣₐₘₚ and Rₜₕᵣₑₛₕ, then the safe maximum heating current for heating each of the wires 8, 10 may be calculated separately for each of the wires 8, 10 substantially continuously or at selected frequent intervals according to:

$$If ( {R}_{meas} < {R}_{thresh} )$$

$${I}_{max} = {I}_{safe}$$

$$Elseif ( {R}_{meas} > {R}_{ramp} )$$

$${I}_{max} = {I}_{high}$$

$$Else$$

$${I}_{max} = {I}_{safe} + \frac{( {I}_{high} - {I}_{safe} ) ( {R}_{meas} - {R}_{thresh} )}{( {R}_{ramp} - {R}_{thresh} )}$$

Iₘₐₓ=safe maximum heating current that may be applied to either of the wires 8, 10 at any particular time;
Rₜₕᵣₑₛₕ=threshold resistance of the wires 8, 10;
Rᵣₐₘₚ=predetermined resistance on the safe side of Rₜₕᵣₑₛₕ;
Rₘₑₐₛ=measured resistance of the wires 8, 10;
I_{safe}=current sufficient to heat the SMA but insufficient to overheat it (such as the safe limit current); and
I_{high}=maximum current intended to heat the SMA wires 8, 10 rapidly that may also be capable of overheating them.

In a practical alternative used in experiments, a linear power ramp was used between Rₜₕᵣₑₛₕ and Rᵣₐₘₚ, which implies a non-linear current ramp.

In operation of the actuator 2, the SMA wire 8 is able to be heated first, for example, to rotate the output shaft 30 in a clockwise direction (as seen in FIG. 1) using the calculated safe maximum heating current for the wire 8, Iₘₐₓ. The wire 8 reverts or contracts to its initial length or shape as it is heated, correspondingly extending or stretching the wire 10. In accordance with the second heating strategy, it will be appreciated that the safe maximum heating current applied through the wire 8 may vary smoothly during heating of the wire 8. After sufficient heating such that the wire 8 has a substantially 100% austenite phase, the wire 8 is then cooled or allowed to cool such that it reverts to having a substantially 100% martensite phase with a constant initial length. While the rapidity at which the wire 8 cools will generally be dependent on both the properties of the alloy used and the geometry of the wire 8, this may be improved by water-cooling or fan-forcing air across the surface(s) of the wire 8.

An electric current of the magnitude of the safe maximum heating current, Iₘₐₓ, determined for the wire 10 may then be applied across the stretched wire 10 to heat the wire 10. This similarly results in the wire 10 reverting or contracting to its initial length or shape, thereby rotating the shaft in a counter-clockwise direction and extending or stretching the wire 8. Again, from the above it will be appreciated the safe maximum heating current, Iₘₐₓ, for the wire 10 may change during the heating of the wire 10. As such, by the alternate heating of the wires 8, 10 by the application of selected electric maximum safe heating currents, the SMA actuator 2 formed by the antagonistic pair of SMA elements 4, 6 is able to provide rapid reciprocating rotation of the output shaft 30 to perform mechanical work.

It will be appreciated alternatively that the stretched wire 10 may alternatively be heated while the contracted wire 8 is cooling but is still hot, provided the wire 8 has cooled down sufficiently by the time the wire 10 is fully heated. Similarly, the stretched wire 8 may subsequently be heated while the contracted wire 10 is cooling but is still hot.

While the safe resistance or the threshold resistance, Rₜₕᵣₑₛₕ, for each wire 8, 10 can be determined empirically during the set up, preferably it is calculated automatically each time on start-up of the actuator 2 for example, or on command. This can be done by calculating the hot and cold resistances of each wire 8, 10 before proceeding to carry out motion commands. This would allow any variation in the resistance levels of the SMA wires 8, 10 to be compensated for by the controller 44.

Advantageously, the design of the controller 44 also allows for inaccurate current regulators 50, where the actual current is only approximately equal to the commanded current. The signal processor 54, having current feedback loops for each of the wires 8, 10 that are formed by respective current sensors 58, can compensate for any inaccuracies in the regulators 50 by comparing and issuing adjusted current command signals 68 to the current regulators 50 so as to bring the actual currents being applied through the wires 8, 10 closer to the commanded currents.

### EXAMPLES

The present invention is further described by the following non-limiting examples.

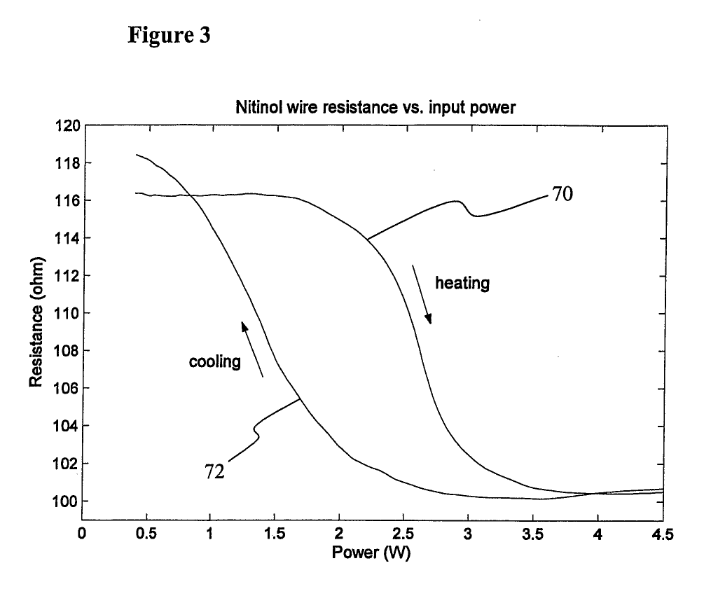

FIG. 3 is a graph of the electrical resistance of an approximately 1 meter long 0.1 mm diameter SMA wire such as the wire 8 shown in FIG. 1 (or similarly the wire 10, for example) formed from nitinol versus electrical heating input power during heating and cooling of the wire 8. A very slow power ramp was applied to the wire 8, starting at 0 watts, whereat the wire 8 has a substantially martensite phase. The power (or applied current) was increased at a rate of 0.1 watts per second to a power level of 4.8 watts which is just off the edge of the graph in FIG. 3, whereat the wire 8 has a substantially austenite phase. The power was then decreased at 0.1 watts per second to zero, whereat the wire 8 again has a substantially martensite phase. The slow rate at which the power was changed ensured that the wire 8 was always close to its equilibrium temperature for the power level being applied. Thus, the temperature of the wire 8 when the power reaches 2 watts, for example, on the rising or increasing ramp (indicted by reference numeral 70) is almost the same as the temperature of the wire 8 when the power reaches 2 watts on the falling or decreasing ramp (indicated by reference numeral 72). Direct measurement of the temperature of the wire 8 is relatively difficult compared with measuring the electrical input power, so in experiments the latter was used as a proxy for the former.

The graph in FIG. 3 shows the two relevant properties of this and other similar SMAs:

(1) a resistance change caused by the phase change within the SMA material; and

(2) the thermal hysteresis of the phase change.

Starting with the wire 8 cold, and therefore in a mostly martensite phase, the resistance of the wire is 116 ohms. As the wire 8 is heated (curve 70), the resistance begins to drop as the power level reaches 1.7 watts. This indicates that the material has reached the temperature at which martensite phase material begins to transform into austenite. This is typically known in literature as the austenite start temperature (or Aₛ). As the power level continues to rise, the resistance drops sharply and bottoms out at around 101 ohms at around 4 watts, although it has very nearly bottomed out at around 3.5 watts. At this point (ie, about 3.5 watts), the wire 8 has reached the austenite finish temperature ( or A_{f}) and the transformation from martensite to austenite is substantially complete.

Upon cooling (curve 72), the resistance begins to rise as the power level drops to about 3 watts, and it rises steadily to a maximum of around 119 ohms at a power level of about 0.3 watts. Resistance measurements for power levels close to zero have been omitted as they were considered inaccurate. It will be appreciated that the discrepancy between the initial and final cold resistance indicates that the wire 8 is not quite in the same physical state after the power ramp as it was before. Nevertheless, the wire 8 does begin and end in a mostly martensite state.

As discussed above, while the thermal hysteresis associated with a typical SMA precludes the changing temperature of the wire 8 being deduced exactly from its resistance, it is possible to identify a range of temperatures that are consistent with the measured resistance. For example, if the resistance measurement is 110 ohms then the temperature is somewhere between the equilibrium temperature (the temperature at which the wire will effectively stabilise at if heated at a particular power or current level for a long enough duration) for 1.4 watts of heating and the equilibrium temperature for 2.5 watts of heating. Hence, if the resistance is 110 ohms or higher then the temperature of the wire 8 is at or below the equilibrium temperature for 2.5 watts of heating.

The datasheet value for the safe limit current for the wire 8 tested corresponded to a power level of approximately 3.5 watts. While this safe limit current was exceeded in the particular experiment, it is not enough to cause significant thermal damage. Thus, any temperature below the equilibrium for 3.5 watts can be regarded as safe.

According to an embodiment of the present invention, a safe resistance corresponding to a resistance that rules out the possibility of overheating, with a desired safety factor or margin in the value of the resistance, is determined. For the wire 8 having the resistance profile shown in FIG. 3, the resistance of the overheated wire 8 does not exceed 101 ohms. The selected value of the threshold resistance, Rₜₕᵣₑₛₕ, should therefore be a value greater than this, preferably by a desired safety margin or factor. The safety margin should be sufficient to allow for possible noise and inaccuracies in resistance measurements, and strain-induced variations in the resistance of the wire 8. In experiments, a safety margin of around 4% was used, such that a value of 105 ohms (4% greater than 101 ohms) was used as the threshold between safe resistances (>=105) and possibly unsafe resistances (<105).

In experiments, strain induced variations in the resistance are able to be accounted for by calculating an upper bound (at the time the actuator is designed) on the magnitude of the strain-induced resistance change at the relevant temperature, and factoring into this the safety margin for the threshold resistance Rₜₕᵣₑₛₕ. Alternatively, data from position sensors 52 can be used to calculate the actual strain, at least approximately, and hence the resistance change due to strain. This can then be subtracted from the measured resistance value to get a strain-compensated resistance measurement.

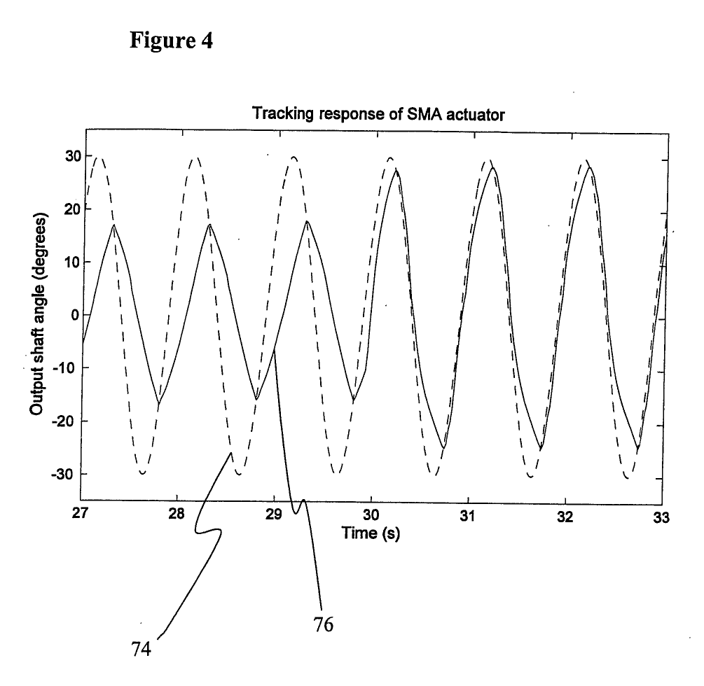

FIG. 4 is a graph of the tracking response of the output shaft 30 of the SMA actuator 2 shown in FIG. 1 to a motion command position signal 60 consisting of a 1 Hz sine wave of amplitude 30 degrees. This command position signal 60 is shown as a dashed line indicated by reference numeral 74, while the solid line 76 shows the angle of the output shaft 30 in response to this command position signal 60. To begin with, a controller 44 for controlling and heating the SMA elements 4, 6 limits the heating current to the safe limit current specified in the data sheet for the type of SMA (nitinol) used, which is 0.18 amps, as per previously proposed heating methods.

After 30 seconds, the controller switches to a heating method according to an embodiment of the present invention. In this case, the heating current is limited to the 0.18 amps whenever the measured resistance is below 105 ohms (ie, 101 ohms+4%), and is limited to the larger value of approximately 0.42 amps (which delivers around 20 watts of Joule heating to the wires 8, 10) whenever the measured resistance is above 118 ohms. In between these two resistance values, the maximum heating current varies between 0.18 and 0.42 amps such that the heating power varies linearly with resistance (ie, the controller implements a linear power ramp from 3.5 watts at 105 ohms to 20 watts at 118 ohms).

As can be seen in FIG. 4, the actuator 2 moves much more quickly (as seen by the steeper response slopes) after the 30 second mark, indicating that the rapid heating method according to an embodiment of the present invention can produce a substantial improvement in the maximum velocity of actuation.

The foregoing describes only one form of the present invention and it will be appreciated that modifications and variations may be made without departing from the spirit and scope of the invention described. Further, it will be appreciated that remarks in the drawings are exemplary only.

It will also be appreciated that SMA actuators according to embodiments of the invention could take many forms. Alternatively, for example, an actuator may have a single element, or further alternatively a plurality of antagonistic pairs working together. Further, the SMA element(s) may not be wires, and may be any suitable shape.

In a further alternative form, an SMA actuator according to an embodiment of the present invention may include a number of elements in parallel and/or series that are able to be simultaneously heated to provide for the actuation of an output element to do mechanical work during shape recovery of the elements substantially in the one direction, such that the actuator may provide a greater force. It will also be appreciated that the external force supplied to stretch the elements when they are relatively cool and close to 100% martensite phase may be provided in an alternate form by separate SMA actuators, or further alternatively by one or more springs or weights that stretch the elements after cooling from a largely austenite phase to a largely martensite phase, for example.

1. A controller for an SMA actuator, the SMA actuator including at least one SMA element, the controller including:
an electrical power source for applying an electrical current through the SMA element;
a sensor to detect change in an electrical resistance of the SMA element; and
a regulator for controlling a magnitude of the applied electrical current, said regulator applying a first current above a safe limit current for the SMA element until a selected change in said electrical resistance is detected and applying a second current less than said first current after said change is detected.

2. A controller as claimed in claim 1, wherein said selected change corresponds to a range of temperatures for the SMA element at and below which thermal damage of the SMA element will not occur.

3. A controller as claimed in claim 1, wherein the selected change includes a safety factor or margin.

4. A controller as claimed in claim 3, wherein the safety factor or margin allows for strain induced variation in the resistance of the SMA element.

5. A controller as claimed in claim 1, wherein the controller progressively reduces the first current applied through the SMA element as a function of the detected electrical resistance.

6. A controller as claimed in claim 5, wherein the controller substantially smoothly reduces the first current applied through the SMA element as a function of the detected electrical resistance.

7. A controller as claimed in claim 5, wherein the reduction of the first current occurs over a range of electrical resistances within, but adjacent to the boundary of, the selected change.

8. A controller as claimed in claim 1, wherein the current applied through the SMA element is a substantially steady DC current.

9. A controller as claimed in claim 1, wherein the current applied through the SMA element is an intermittent DC current.

10. A controller as claimed in claim 1, wherein the current applied through the SMA element is an AC current.

11. A controller as claimed in claim 1, wherein the change in the electrical resistance of the SMA element is detected by measuring the electrical resistance of the SMA element.

12. A controller as claimed in claim 1, wherein the change in the electrical resistance of the SMA element is detected by measuring the electrical impedance or other characteristic indicative of the electrical resistance of the SMA element.

13. A controller as claimed in claim 1, wherein the electrical resistance of the SMA element is detected substantially continuously.

14. A controller as claimed in claim 1, wherein the electrical resistance of the SMA element is detected substantially at selected intervals.

15. A controller as claimed in claim 1, wherein the SMA element is a substantially straight wire.

16. A controller as claimed in claim 1, wherein the SMA element is a substantially helically wound wire.

17. A controller as claimed in claim 15, wherein the SMA actuator includes two or more SMA elements working in parallel.

18. A controller. as claimed in claim 1, wherein the controller has an initialization or calibration mode in addition to a normal operating mode, the initialization or calibration mode measuring and recording the hot and/or cold electrical resistances of the SMA element.

19. A controller as claimed in claim 18, wherein the controller enters the initialization or calibration mode automatically upon the SMA actuator being powered up.

20. A controller as claimed in claim 18, wherein the controller enters the initialization or calibration mode automatically upon command.

21. A controller as claimed in claim 19, wherein the initialization or calibration operation includes applying at least one test current through the SMA element, measuring the electrical resistance to the test current, and determining the selected change from the measured resistance.

22. A controller as claimed in claim 1, including a motion control system for computing the desired degree of actuation of the actuator as a function of the discrepancy between a desired motion or position of an output element of the SMA actuator and a detected actual motion or position of the output element.

23. A controller as claimed in claim 1, wherein a gain of the motion control system is set high so that a small position error will result in a correctional signal that exceeds the safe limit current of the SMA element.

24. A controller as claimed in claim 1, wherein the current regulator is able to apply a third current to maintain the SMA element in an austenite phase, the third current being significantly less than the safe limit current.

25. A controller as claimed in claim 1, wherein, if the measured resistance of the SMA element exceeds a selected upper operating limit or falls below a selected lower operating limit, the controller issues a malfunction or error signal indicating that the actuator is not functioning correctly.

26. All An SMA actuator including:
at least a first SMA element;
an output element operably associated with the SMA element, the output element moving in response to the actuation of the SMA element; and
a controller as claimed in claim 1 for controlling the actuation of the SMA element.

27. An SMA actuator as claimed in claim 26, including a second SMA element, said SMA elements being operably arranged so that the contraction of one of the SMA elements complementarily exerts a stretching force on the other of the SMA elements.

28. A method of heating at least one SMA element of an SMA actuator, the method including:
applying an electrical current through the SMA element; and
detecting change in the electrical resistance of the SMA element; wherein
a first current above a safe limit current for the SMA element is applied until a selected change in said electrical resistance is detected and a second current less than said first current is applied after said change is detected.

29. A method as claimed in claim 28, wherein said selected change corresponds to a range of temperatures for the SMA element at and below which thermal damage of the SMA element will not occur.

30. A method as claimed in claim 28, wherein the selected change includes a safety factor or margin.

31. A method as claimed in claim 30, wherein the safety factor or margin allows for strain induced variation in the resistance of the SMA element.

32. A method as claimed in claim 28, including progressively reducing the first current applied through the SMA element as a function of the detected electrical resistance.

33. A method as claimed in claim 32, including substantially smoothly reducing the first current applied through the SMA element as a function of the detected electrical resistance.

34. A method as claimed in claim 32, wherein the reduction of the first current occurs over a range of electrical resistances within, but adjacent to the boundary of, the selected change.

35. A method as claimed in claim 28, wherein the current applied through the SMA element is a substantially steady DC current.

36. A method as claimed in claim 28, wherein the current applied through the SMA element is an intermittent DC current.

37. A method as claimed in claim 28, wherein the current applied through the SMA element is an AC current.

38. A method as claimed in claim 28, including detecting the change in the electrical resistance of the SMA element by measuring the electrical resistance of the SMA element.

39. A method as claimed in claim 28, including detecting the change in the electrical resistance of the SMA element by measuring the electrical impedance or other characteristic indicative of the electrical resistance of the SMA element.

40. A method as claimed in claim 28, including detecting the electrical resistance of the SMA element substantially continuously.

41. A method as claimed in claim 28, including detecting the electrical resistance of the SMA element substantially at selected intervals.

42. A method as claimed in claim 28, wherein the SMA element is a substantially straight wire.

43. A method as claimed in claim 28, wherein the SMA element is a substantially helically wound wire.

44. A method as claimed in claim 42, wherein the SMA actuator includes two or more SMA elements working in parallel.

45. A method as claimed in claim 28, including measuring and recording the hot and/or cold electrical resistances of the SMA element as part of an initialization or calibration operation.

46. A method as claimed in claim 45, wherein the initialization or calibration operation is performed automatically upon the SMA actuator being powered up.

47. A method as claimed in claim 45, wherein the initialization or calibration operation is performed automatically upon command.

48. A method as claimed in claim 45, including as part of the initialization or calibration operation applying at least one test current through the SMA element, measuring the electrical resistance to the test current, and determining the selected change from the measured resistance.

49. A method as claimed in claim 28, including computing the desired degree of actuation of the actuator as a function of the discrepancy between a desired motion or position of an output element of the SMA actuator and a detected actual motion or position of the output element.

50. A method as claimed in claim 28, including applying a third current to maintain the SMA element in an austenite phase, the third current being significantly less than the safe limit current.

51. A method as claimed in claim 28, including, if the measured resistance of the SMA element exceeds a selected upper operating limit or falls below a selected lower operating limit, issuing a malfunction or error signal indicating that the actuator is not functioning correctly.
